(19) United States
(12) Patent Application Publication
(10) Pub. No.: US 2011/0274339 A1
(43) Pub. Date: Nov. 10, 2011

(54) Method for kinetic characterization from temporal image sequence

(75) Inventors: Shih-Jong J. Lee, Bellevue, WA (US); Seho Oh, Bellevue, WA (US); Samuel V. Alworth, Seattle, WA (US)

(73) Assignee: DRVision Technologies LLC

(21) Appl. No.: 13/135,711

(22) Filed: Jul. 13, 2011

Related U.S. Application Data
(62) Division of application No. 11/604,590, filed on Nov. 22, 2006.

(51) Int. Cl. G06K 9/00

(52) U.S. Cl. 382/133

(57) ABSTRACT

A computerized derivable kinetic characterization measurement method for live cell kinetic characterization inputs kinetic recognition data for a plurality of time frames. A single cell measurement step is performed using the kinetic recognition data for a plurality of time frames to generate single cell feature for a plurality of time frames output. The single cell feature includes cell morphological profiling feature. A kinetic measurement step uses the single cell feature for a plurality of time frames to generate kinetic feature output. A trajectory measurement step uses the single cell feature for a plurality of time frames and the kinetic feature to generate trajectory feature output. An interval measurement step uses the kinetic feature to generate interval feature output. A cell state classifier step uses the interval feature to generate cell state output. A state based measurement uses the single cell feature, the kinetic feature and the cell state to generate state based feature output.

### CROSS REFERENCE TO RELATED APPLICATION

This is a divisional of U.S. application Ser. No. 11/604,590, filed Nov. 22, 2006.

### GOVERNMENT INTERESTS

STATEMENT AS TO RIGHTS TO INVENTIONS MADE UNDER FEDERALLY SPONSORED RESEARCH AND DEVELOPMENT

### TECHNICAL FIELD

This invention relates to the kinetic and morphological characterization of moving cells from temporal image sequence.

### BACKGROUND OF THE INVENTION

Cell motility is a fundamental process central to embryonic development, immune response, wound healing, angiogenesis, tissue engineering and various disease processes, including cancer metastasis. Cell motility plays a role in the body's immune and inflammation response; for example T cell's hunt down and kill target cells, neutrophils move to sites of bacterial infection, and leukocytes migrate to infected and inflamed areas, and is also critical to related diseases (e.g. multiple sclerosis, autoimmune disease, adult respiratory disease syndrome and many more). Studies of single cell motility shed light on the internal workings of the molecular cell motility machinery, and can also be used as an indicator of cell response to external stimuli. They are conducted in many disciplines covering the broad life sciences spectrum from basic research to drug discovery and disease related research.

The study of the mechanisms underlying cell motility is an important field in basic cell biology. Single cell motility assays allow scientists to put findings from a molecular/subcomponent level in the context of whole cell behavior; specifically movement. The molecular motility machinery includes actin filament based protrusive structures, microtubule cytoskeleton, and the cell's attachments to the substratum, also known as focal adhesions. It also involves the study of relevant signaling pathway elements. For example, recent significant progress has been made in identifying the molecular components involved in signaling to actin. These include signaling molecules such as Cdc42 and Rho family GTPases, the phospholipid PIP2, PAK and LIM kinase, WASp/Scar nucleation-promoting factors and the Arp2/3 complex. These elements act in concert to bring about coordinated cell movement.

Individual cell motility image informatics could provide a powerful tool to quantitatively analyze the impact of experimental treatments (e.g. drug treatment or gene depletion) on the cell motility process in all of the above fields. In comparison with cell population transwell assays, including Boyden-chamber assays, single cell assays allow scientists to obtain more detailed information about the subcellular and molecular mechanisms underlying the cell motility process. In comparison to cell population wound healing assays, single cell assays eliminate complicated interpretations because of cell—cell contact in the wound model.

To make precise measurements and comparisons of various aspects of motility computer image processing technology and phase contrast microscopy such as Hobson BacTracker “blob and track” method (Q N Karim, R P H Logan, J Puels, A Karnholz, M L Worku “Measurement of motility of Helicobacter pylor, Campylobacter jejuni, and Escherichia coli by real time computer tracking using the Hobson BacTracker”, Journal Clinical Pathology 1998; 51:623-628) were used to measure several indices of motility objectively, reproducibly, and precisely, which is difficult to achieve without computer assistance. Prior art motility measurements include direction, curvature rates, curvilinear velocity, and straight line velocity, which could be measured accurately, objectively. Some specific prior art kinetic measurements are
Track—A track is the path traveled by a moving cell. It is measured from the point of detection by the computer until the cell disappears from view or moves out of the analysis window
Stop—A stop occurs when the speed of the bacterial cell falls below the stop speed by Brownian movement of dead cell.
Run—A run is the track between two stops
Curvilinear velocity (CLV)—This is the length of a track divided by the time taken to travel it. It is calculated by summing the incremental distances moved in each frame along the sampled path and divided by the total time
for the track. It is measured for tracks (total path length) and for runs (incremental path lengths between two stops).
Straight line velocity (SLV)—This is calculated by measuring the straight line distance between the start and end point of the track and dividing by the time taken to travel it.
Track linearity percentage (TL %)—This is the ratio of the straight line velocity to curvilinear time velocity×100 (SLV/CLV(100)).
Curvature rate (CVRT/s)—This is measured using the incremental sum of change in angle as the object changes direction for the length of the track. It includes the sign to reflect the direction of change.
Stop time (STTM)—This is the time of a defined stop between two adjacent runs.
Stop frequency (STFRQ)—This is a measure of how often the cell stops. The time is measured from the start of a run through to the end of the following stop or the start of a new run. This time is divided into 1 to give a frequency in Hz or times/s.

Another prior art automated system in which images are acquired and are automatically processed to yield high-content motility and morphological data (“Alfred Bahnson, Charalambos Athanassiou, Douglas Koeblerl, Lei Qian, Tongying Shun, Donna Shields, Hui Yu, Hong Wang, Julie Goff, Tao Cheng, Raymond Houck and Lex Cowsert, “Automated measurement of cell motility and proliferation”, BMC Cell Biology 2005, 6:19″). The kinetic characterization measurements are simple field measurements such as average velocities, exponential growth, as monitored by total cell area or absolute cell number,

To move directionally, cells first become functionally and structurally polarized by establishing a chemical and morphological distinction between their front and their rear. After achieving cell polarization, directional motility is generally characterized in terms of four subcomponent processes: protrusion of cell front, its adhesion to substratum, translocation of cell body and de-adhesion of the rear. Repeated cycles of this process result in sustained cell migration. Even though persistent random walk is a suitable model to characterize long term cellular motility, there are distinctive states that a cell is undergoing during a short duration. These states are important to predict the next frame for our kinetic recognition. For the purpose of kinetic recognition, the possible cell states include “idle”, “active motion”, “random motion”, or state transitions. A cell 100 tends to stay in one state for a number of frames and then transition into another state.

Unfortunately, the prior art methods are not precise enough to follow transient or minor changes in motility because there are no morphological characterizations included in the kinetic measurements. Furthermore, the characterization are not separated depending on the cell states. This introduces extraneous source of variability that could significant degrade the effectiveness (sensitivity and specificity) of the kinetic characterizations.

### Objects and Advantages

This invention discloses a comprehensive set of cell motility measurements for kinetic characterization including new motility and kinetic morphology measurements in an analysis environment for scientists to efficiently generate reproducible high quality motility assay outcomes. Specifically, cell morphological profiling measurements are provided for detailed characterization of cell morphological changes over time. In addition, a cell state classifier automatically determines cell states. This allows kinetic characterization using cell state profiling. It also facilitates state based characterization for the kinetic characterization measurements that could further characterize cellular object's behavior that cannot be captured using any prior art measurements.

The objectives of the moving cell detection method of this invention are:
(1) Divide characterization measurements into single cell measurements, kinetic 120 measurements and trajectory measurements for flexible and efficient feature extraction and kinetic characterization;
(2) Perform cell morphological profiling measurements for detailed characterization of cell morphological changes over time.
(3) Perform cell state determination for kinetic characterization using cell state profiling.
(4) Perform state based characterization for the kinetic characterization measurements that could further characterize cellular object's behavior that cannot be captured using any prior art measurements.

### SUMMARY OF THE INVENTION

A computerized derivable kinetic characterization measurement method for live cell kinetic characterization inputs kinetic recognition data for a plurality of time frames. A single cell measurement step is performed using the kinetic recognition data for a plurality of time frames to generate single cell feature for a plurality of time frames output. The single cell feature includes cell morphological profiling feature. A kinetic 135 measurement step uses the single cell feature for a plurality of time frames to generate kinetic feature output. A trajectory measurement step uses the single cell feature for a plurality of time frames and the kinetic feature to generate trajectory feature output. An interval measurement step uses the kinetic feature to generate interval feature output. A cell state classifier step uses the interval feature to generate cell state output. A state based measurement uses the single cell feature, the kinetic feature and the cell state to generate state based feature output.

### BRIEF DESCRIPTION OF THE DRAWINGS

The preferred embodiment and other aspects of the invention will become apparent from the following detailed description of the invention when read in conjunction with the accompanying drawings, which are provided for the purpose of describing embodiments of the invention and not for limiting same, in which:

FIG. 1 shows the processing flow for the computerized derivable kinetic characterization measurement method of the invention;

FIG. 2 shows the processing flow for the cell morphological profiling measurement method;

FIG. 3 shows the processing flow for the cell morphological grayscale profiling measurement method;

FIG. 4 shows an illustration of the polar domain morphological profile and processes.

### DETAILED DESCRIPTION OF THE INVENTION

### I. Kinetic Characterization Overview

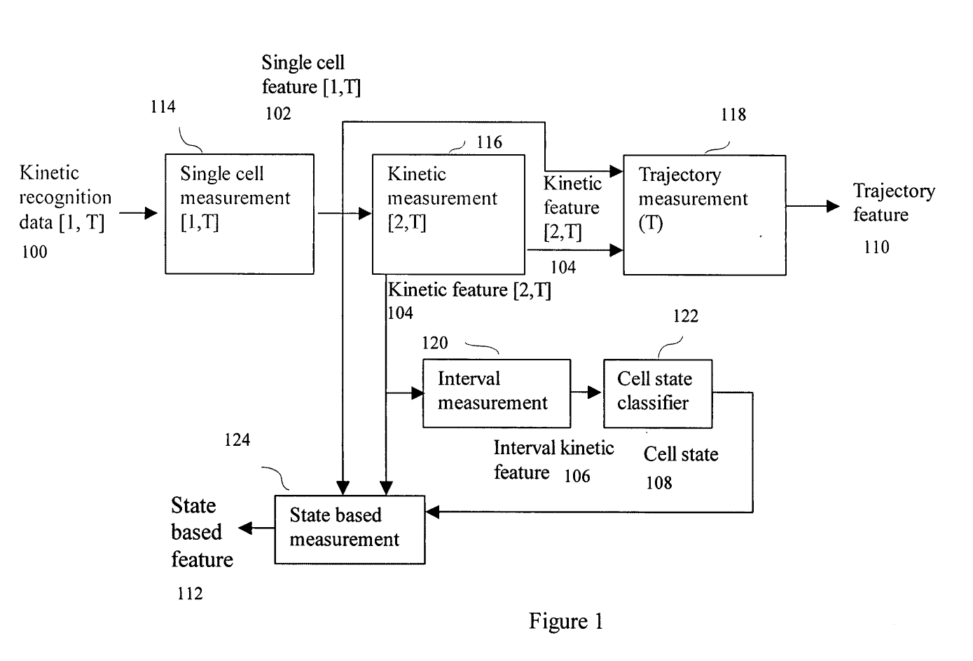

This invention discloses a comprehensive and computerized derivable kinetic characterization measurement method for live cell kinetic characterization including new motility and kinetic morphology measurements in an analysis environment for scientists to efficiently derive reproducible high quality motility assay outcomes. When integrated with the knowledge discovery environment tool. It can be used to find new measurements that improve experimental results, and support advanced research. The processing flow for the derivable kinetic characterization measurement method is shown in FIG. 1. The kinetic recognition data 100 from a plurality of image frames ([1,T] designates image frames 1 to T) are inputted and used by a single cell measurement step 114. The kinetic recognition data 100 contains cell of interest mask 200 and cell image 300, that is, grayscale image of the cell. The single cell measurement 170 step 114 uses kinetic recognition data 100 to perform feature measurements for each cell of interest at each image frame, separately. This results in single cell feature 102 for a plurality of time frames. The kinetic measurement step 116 uses the single cell feature 102 for a plurality of time frames to generate kinetic feature 104. Kinetic feature 104 is measured between image frames. Therefore, for a single cell feature 102 of [1,T], the kinetic feature 104 is available from image frames 2 to T. The single cell feature 102 for a plurality of time frames and the kinetic feature 104 are processed by a trajectory measurement step 118 to generate trajectory feature output 110. Trajectory feature 110 is measured once per cell trajectory.

The current invention includes a cell state classifier 122 that uses interval kinetic feature 106 to classifier cell frame interval into one of the cell states 108. The cell state 108 can be used to generate state based feature 112. As shown in FIG. 1, an interval measurement step 120 processes kinetic feature 104 to generate interval kinetic feature output 106. The interval kinetic feature 106 is used by the cell state classifier 122 to 185 generate cell state output 108. The cell state output 108 is associated with at least one selected cell for at least one selected image frame. The cell state 108 along with the single cell feature 102 and the kinetic feature 104 are processed by a state based measurement step 124 to generate state based feature output 112.

### II. Single Cell Measurement

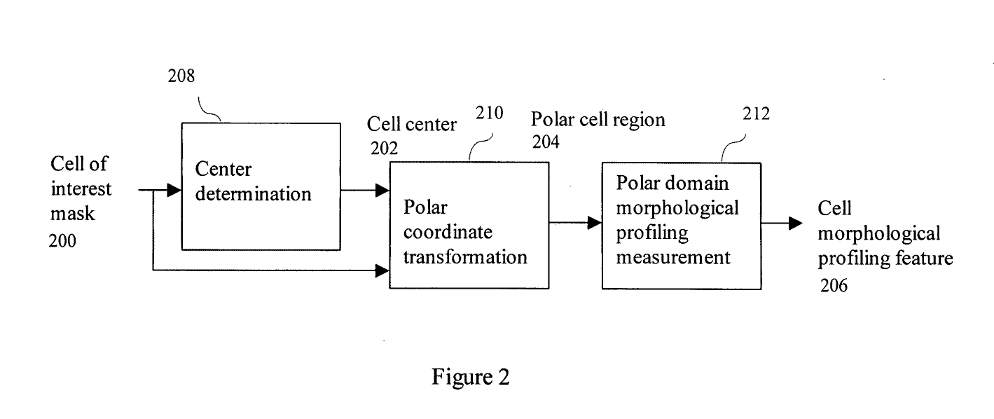

The static features that can be measured by the single cell measurement method include the position of the cell, cell perimeter, cell area, bipolarity index (cell length/cell width), form factor [(4πX cell area)/(Perimenter²)], etc. They can be derived from the cell of interest mask. In addition, the current invention include a computerized cell morphological profiling measurement method that generate at least one cell morphological profiling feature. The cell morphological profiling measurement processing flow is shown in FIG. 2.

As shown in FIG. 2, the cell morphological profiling measurement method inputs at least one cell of interest mask 200 and performs center determination 208 using the cell of interest mask 200. This generates a cell center output 202. The cell center 202 along with the cell of interest mask 200 are used by a polar coordinate transformation step 210 to generate polar cell region output 204. The polar cell region 204 is used by a polar 205 domain morphological profiling measurement step 212 to generate cell morphological profiling feature output 206.

In one preferred but not limiting embodiment of invention, the center determination step 208 determines the cell center 202 from the cell of interest mask 200 by performing a distance transform to the cell of interest mask 200 and using the maximum position of the distance transformed cell of interest mask 200 as the cell center. If multiple maximum positions exist, the average of maximum positions is used as the cell center 202. In another embodiment of the invention, the position closest to the average of maximum positions is used instead. Those skilled in the art should recognize that other methods of center determination such as the centroid position of the cell of interest mask or the center of the bounding box for the cell of interest mask, etc. could be used as center center that are all within the scope of the invention.

The cell center 202 position is used to perform a polar coordinate transformation 210. In a preferred but not limiting embodiment of the invention, the polar coordinate transformation 210 is performed by the following steps:

In a general purpose embodiment, the horizontal direction (x-axis) is chosen as the starting direction. The rectangular to polar coordinate transformation steps are listed as follows:
1. Given the reenter point (x_c, y_c)
2. Select the radius r of the circular region
3. Select a radial sampling factor R
4. Select a angular sampling factor A
5. Determine the width of the transformed region as w=2π/A
6. Determine the length of the transformed region as L=r/R
7. Determine the value of each point of the transformed region by the sequence specified in the following pseudo code:

```
For (i = 0; i < w; i++)
{
  line_direction = i*A;
  For (j = 0; j < L; j++)
  {
radius = j*R;
Determine the pixel P that is closest to the point that is at a radius
  distance from (x_c, y_c) along line_direction;
  Set the converted region value at index i and j as: PC[i][j] = pixel value
  of P;
  }
  }
```

After polar coordinate transformation, polar cell region is generated. The cell morphological profiling measurement is performed on the polar domain using the polar cell region 204 to generate cell morphological profiling features 206. For a given angle range, many features could be derived from the polar cell region. In one preferred but not 250 limiting embodiment of the invention, the features include
(1) Maximum radius: the maximum radius value of the polar cell region within the range.
(2) Minimum radius: the minimum radius value of the polar cell region within the range.
(3) Mean radius: the average radius value of the polar cell region within the range.
(4) Normalized mean radius: the mean radius normalized by the maximum radius.
(5) Radius standard deviation: the standard deviation value of the radii within the range.
(6) Radius coefficient of variation: the radius standard deviation divided by the mean radius.
(7) Processes count: the number of radius peaks within the range.
(8) Mean process radius: the average radius of the peaks within the range.
(9) Normalized mean process radius: the mean radius normalized by the maximum radius.
(10) Process radius standard deviation: the standard deviation value of the radii of the peaks within the range
(11) Process radius coefficient of variation: the process radius standard deviation divided by the mean process radius.
Those skilled in the art should recognize that other features such as rank statistics such as median, a percentile value (such as 10 percentile, 25 percentile, 75 percentile, 90 percentile values) could be used to generate cell morphological profiling features on polar cell region.

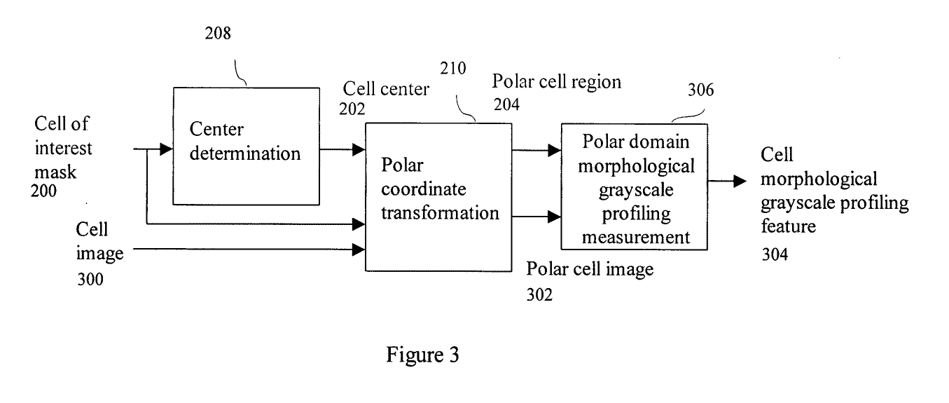

In an alternative embodiment of the invention, a cell morphological grayscale profiling measurement processing flow is shown in FIG. 3. As shown in FIG. 3, the cell morphological grayscale profiling measurement method inputs cell of interest mask 200 as well as cell image 300, that is the grayscale image of the cell. Those skilled in the art should recognize that the grayscale image could contain one or multiple channels of color or multiple spectrum images. The center determination 208 using the cell of interest mask 200 to generate a cell center output 202. The cell center 202 along with the cell of interest mask 200 and the cell image 300 are processed by a polar coordinate transformation step 210 to generate polar cell region output 204 and polar cell image 302. Both the polar cell region 204 and the polar cell image 302 are used by a polar domain morphological grayscale profiling measurement step 306 to generate cell morphological grayscale profiling feature output 304 including grayscale features.

In one preferred but not limiting embodiment of the invention, for a given angle range the cell morphological grayscale profiling features 304 include
(1) Maximum intensity: the maximum grayscale intensity value of the polar cell image within the polar cell region within the range.
(2) Minimum intensity: the minimum grayscale intensity value of the polar cell image within the polar cell region within the range.
(3) Mean intensity: the average grayscale intensity value of the polar cell image within the polar cell region within the range.
(4) Normalized mean intensity: the mean intensity normalized by the maximum grayscale intensity.
(5) Intensity standard deviation: the standard deviation value of the grayscale intensities of the polar cell image within the polar cell region within the range.
(6) Intensity coefficient of variation: the intensity standard deviation divided by the mean intensity.

Those skilled in the art should recognize that other features such as intensity rank statistics such as median intensity, a percentile value (such as 10 percentile, 25 percentile, 75 percentile, 90 percentile values) of the grayscale intensities could be used to generate cell morphological profiling features on polar cell region. Furthermore, pre-processing such as band-pass, high-pass filtering, edge enhancement, texture enhancement such as co-occurrence matrix based enhancement could be applied to the grayscale intensity before the measurement of the cell morphological grayscale profiling features.

The above measurements can be calculated for the whole range (0 to 2π) or for each of multiple selected ranges. Furthermore, the following features could be derived from features of multiple angle ranges:
(1) Mean of the features from multiple angle ranges.
(2) Standard deviation of the features from multiple angle ranges.
(3) Contrast of the features between two selected angle ranges: this is calculated by selecting two angle ranges and calculating signed difference or absolute difference of their feature values.
(4) Correlation of the features between multiple selected angle ranges.

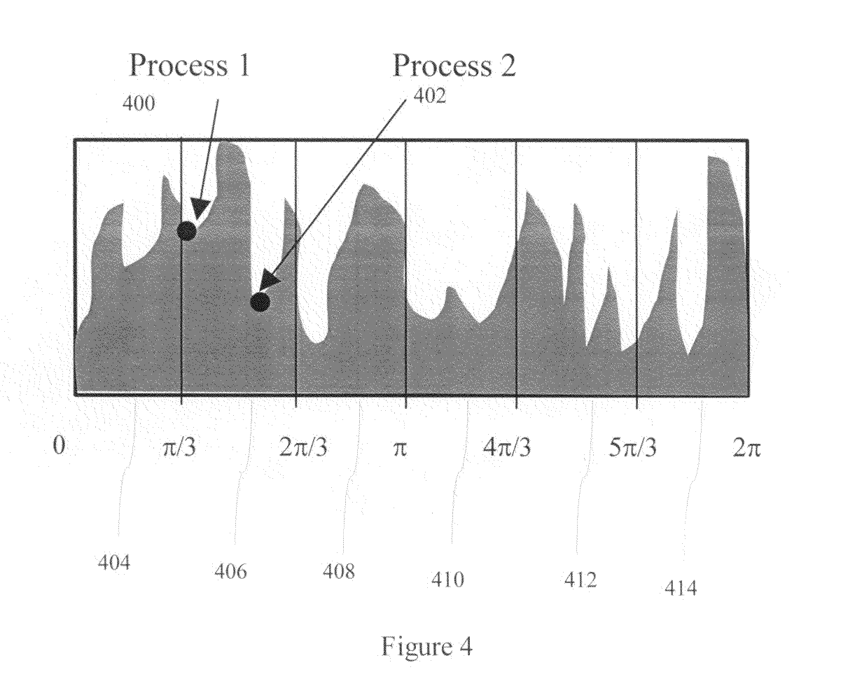

FIG. 4 illustrates of the polar domain morphological profile and examples of process 400, 402. In this illustration, the polar domain is divided into 6 ranges: 0-π/3 (404), π/3-2π/3 (406), 2π/3-π (408), π-4π/3 (410), 4π/3-5π/3 (412), 5π/3-2π (414).

### III. Kinetic Measurement

Kinetic measurements are those that are measured between image frames. In one embodiment of the invention, the measurements such as the displacement vector Sᵢ, intersegmental angle θᵢⱼ, and total displacement vector Tₖ that can be calculated at each time frame k throughout the total time series of N frames for kinetic features. Additionally velocity vectors, acceleration vectors as well as change of any single cell static features between specified time interval T, (β_{t+T}−βₜ) including the magnitude and sign can be calculated for kinetic features. The change of single cell static features includes the changes of the cell morphological profiling feature or cell morphological grayscale profiling features for the kinetic features.

### IV. Trajectory Measurement

Trajectory measurements are those that are measured once per cell trajectory. In one embodiment of the invention, the trajectory measurement implements common trajectory features include average speed ( [symbol] Sᵢ [symbol] ), total displacement vector T (|T|,φ_{T}), maximal displacement (line from trajectory to further point on the trajectory) vector M (|M|, φ_{M}), total displacement speed (TDS, |T|/N), maximum relative distance to origin (MRDO, |M|/N), the average MRDO vector (M/N) and the average total displacement vector (T/N). In addition, statistics such as mean and standard deviation of the static and kinetic measurements are calculated for each trajectory, as well as other statistics that describe the distribution of the static or kinetic measurements such as skewness and kurtosis. The static and kinetic features include cell morphological profiling feature and cell morphological grayscale profiling feature.

### V. Interval Measurement

Instead of calculating trajectory measurements for the complete trajectory of a cell, interval features can be calculated by defining a time interval and performing trajectory measurements only the cell trajectory within each time interval.

### VI. State Based Measurement

For the purpose of kinetic characterization, we classified the possible cell states into “idle”, “active motion”, “random motion”, or state transitions. A cell tends to stay in one state for a number of frames and then transition into another state. In one preferred 365 embodiment of the invention, a cell state classifiers that uses interval features to automatically determine cell states. The trajectory features or interval features of a cell can then be based on states. That is, we could repeat the same trajectory measurements for each state of a cell trajectory. This provides a wealth of information to comprehensively characterizing cell motion.

The invention has been described herein in considerable detail in order to comply with the Patent Statutes and to provide those skilled in the art with the information needed to apply the novel principles and to construct and use such specialized components as are required. However, it is to be understood that the inventions can be carried out by specifically different equipment and devices, and that various modifications, both as to the equipment details and operating procedures, can be accomplished without departing from the scope of the invention itself.

What is claimed is:

1. A computerized cell morphological grayscale profiling measurement method for live cell kinetic characterization comprising the steps of:
a) Inputting cell of interest mask and cell image;
b) Performing center determination using the cell of interest mask having cell center output;
c) Performing polar coordinate transformation using the cell center, the cell of interest mask and the cell image having polar cell region and polar cell image output;
d) Performing polar domain grayscale morphological profiling measurement using the polar cell region and polar cell image having cell morphological grayscale profiling feature output.

2. The cell morphological grayscale profiling feature of claim 1 is derived from a given angle range and selects feature from a set consisting of maximum intensity, minimum intensity, mean intensity, normalized mean intensity, intensity standard deviation, intensity coefficient of variation and intensity rank statistics.

3. The computerized cell morphological grayscale profiling measurement method of claim 1 wherein the cell morphological grayscale profiling feature is derived from multiple angle ranges.

4. The computerized cell morphological grayscale profiling measurement method of claim 1 further calculates change of at least one cell morphological grayscale profiling feature between a specified time interval.

5. The computerized cell morphological grayscale profiling measurement method of claim 1 further calculates trajectory feature of at least one cell morphological grayscale profiling feature for a specified time interval.

6. The computerized cell morphological grayscale profiling measurement method of claim 1 further inputs cell state and calculates state based trajectory feature of at least one cell morphological grayscale profiling feature for a specified time interval.
